(19) United States
(12) Patent Application Publication
(10) Pub. No.: US 2007/0256706 A1
(43) Pub. Date: Nov. 8, 2007

(54) Multiple bath CO2 cleaning

(76) Inventors: Esko Ahlbom, Uppsala (SE); Josefine Andreassen, Solna (SE); Joachim Karthauser, Sollentuna (SE); Kenneth Stig Lindqvist, Skarpnack (SE); Anders Marcusson, Lidingo (SE)

Correspondence Address: THE BOC GROUP, INC., 575 MOUNTAIN AVENUE, MURRAY HILL, NJ, 07974-2064, US

(21) Appl. No.: 11/732,954

(22) Filed: Apr. 5, 2007

(30) Foreign Application Priority Data
Apr. 6, 2006 (EP) EP 06007310.3

(51) Int. Cl. B08B 7/04

(52) U.S. Cl. 134/10

(57) ABSTRACT

A method is provided for processing parts in more than one bath of dense phase carbon dioxide wherein the processing includes transferring dense phase carbon dioxide from a storage tank to a cleaning chamber, processing said parts in said cleaning chamber with said dense phase carbon dioxide, withdrawing at least a part of said dense phase carbon dioxide from said cleaning chamber, distilling said withdrawn dense phase carbon dioxide, and transferring said distilled carbon dioxide back to said storage tank, wherein said distilled carbon dioxide is cooled prior to being transferred to said storage tank and said cooling is carried out depending on the temperature and/or the pressure in the storage tank and/or the cleaning chamber.

The invention relates to a method for processing parts in carbon dioxide.

Dry cleaning using liquid carbon dioxide is known as an environmentally friendly cleaning technique with favorable cleaning properties. Liquid carbon dioxide dry cleaning can be used to remove contaminants from garments or textiles as well as from metal, machinery, workpieces or other parts.

In a typical dry cleaning cycle the parts are cleaned in a cleaning chamber which has been filled with liquid carbon dioxide from a storage tank. When the cleaning is finished the liquid carbon dioxide is withdrawn from the cleaning chamber and passed to a still for distillation in order to remove contaminants from the liquid carbon dioxide. The distilled carbon dioxide is then returned to the storage tank for later use.

Often such cleaning is subsequently carried out in more than one bath of carbon dioxide. At the end of the cleaning in one such bath the used carbon dioxide is withdrawn from the cleaning chamber, distilled, and transferred back into the storage tank. The storage tank is designed for a specific maximum pressure and thus when carbon dioxide is passed into the storage tank it has to be taken care that the pressure within the storage tank does not exceed its maximum design limit.

Therefore, between two subsequent baths the distilled carbon dioxide is normally cooled down before being transferred back into the storage tank. This is partially done by a cooling machine which runs most of the time during the distillation process. In practice the cooling machine also runs during evacuation of the cleaning chamber and when the storage tank is cooled down. By cooling the distilled carbon dioxide, cold carbon dioxide is added into the storage tank and thus the risk of an unacceptable pressure increase is avoided. However, since the pressure is held down the temperature within the storage tank drops from one cycle to another until it reaches an equilibrium temperature, normally between −5° C. and +15° C., depending on the heat input from the surroundings.

In dry cleaning systems, water is useful as an additive in order to assist the removal of hydrophilic stains. Water and mixtures of water and water soluble surfactants can form aggregates in carbon dioxide at temperatures below 5° C. to 9° C. Thus, when using a multiple bath cleaning process as described above the cleaning efficiency will decrease from bath to bath due to the decreasing temperature.

Similar problems occur when dense phase carbon dioxide is used for impregnation or extraction of various materials. In that case higher temperatures would be preferable to increase the diffusion into or out of the material.

### BRIEF DESCRIPTION OF THE DRAWINGS

For a more complete understanding of the present invention, reference may be had to the following description taken in conjunction with the accompanying drawings, of which:

FIG. 1 schematically shows the distillation part of a carbon dioxide dry cleaning apparatus.

FIG. 2 schematically shows another embodiment to increase the temperature in the cleaning chamber.

FIG. 3 schematically shows another embodiment to increase the temperature in the cleaning chamber.

### DETAILED DESCRIPTION OF THE INVENTION

A method is provided which allows to process parts in dense phase carbon dioxide running multiple baths of dense phase carbon dioxide.

This method for processing parts in more than one bath of dense phase carbon dioxide wherein said processing in one of said baths comprises the steps of
a) transferring dense phase carbon dioxide from a storage tank to a cleaning chamber,
b) processing said parts in said cleaning chamber with said dense phase carbon dioxide,
c) withdrawing at least a part of said dense phase carbon dioxide from said cleaning chamber,
d) distilling said withdrawn dense phase carbon dioxide, and
e) transferring said distilled carbon dioxide back to said storage tank,
   wherein said distilled carbon dioxide is cooled before step e) depending on the temperature and/or on the pressure in the cleaning chamber.

The term “dense phase carbon dioxide” shall mean liquid carbon dioxide or supercritical carbon dioxide, such as wherein liquid carbon dioxide at a pressure between 30 and 60 bar, or at a pressure between 35 and 55 bar, is used.

A multiple bath process shall mean a process wherein the parts or objects are processed in more than one bath of dense phase carbon dioxide and wherein the above mentioned steps a) to e) are repeatedly carried out.

According to the invention the temperature within the storage tank and within the cleaning chamber is controlled when using a multiple bath program. After distillation the temperature of the distilled carbon dioxide is higher than the temperature of the carbon dioxide stored in the storage tank. So the distilled carbon dioxide is normally cooled down before entering the storage tank. By controlling the cooling of the distilled carbon dioxide the temperature of the carbon dioxide within the cleaning chamber is controlled and can be set to a desired level.

In the storage tank the carbon dioxide is stagnant and stratified and thus its liquid and its gaseous phase are sometimes not in equilibrium. On the other hand, during the actual processing in the cleaning chamber the parts are normally rotated whereby the dense phase carbon dioxide is revolved and an equilibrium state between the liquid and the gaseous carbon dioxide is achieved. Therefore, the cooling of the distilled carbon dioxide is carried out depending on the temperature within the cleaning chamber rather than on the temperature of the carbon dioxide in the storage tank. But in some cases it might be advantageous to additionally measure the temperature within the storage tank, for example because the temperature sensor is easier to install.

In one embodiment the cooling of the distilled carbon dioxide is controlled in a manner that the temperature in said cleaning chamber increases from bath to bath. That means, the temperature before each step e) is lower than the temperature after step e) that is after the distilled carbon dioxide has been transferred to the storage tank. In other words, the distilled carbon dioxide which is transferred into the storage tank and subsequently into the cleaning chamber has a higher temperature than the temperature of the carbon dioxide within the storage tank. With increasing temperature the solubility of water, surfactants, or other additives in the dense phase carbon dioxide increases and a higher cleaning performance is achieved.

The parts are subsequently processed in a plurality of baths, such as for example 3 to 12 baths, of dense phase carbon dioxide. When cleaning garments with liquid carbon dioxide the number of baths may be between 3 and 6. For extraction of oils and similar contaminants from various objects it is preferred to repeat the processing or extraction cycle a plurality of times, such as for example 6 to 12 times. For heavily contaminated goods, for example catalysts or some leather types, use more than 12 baths, such as for example 18 or more baths which are then of shorter duration in order to extract oil and other impurities.

By the control of the temperature of the distilled carbon dioxide which is returned into the storage tank, the temperature of the dense phase carbon dioxide which is used in the following processing cycle is high enough to ensure processing performance.

When the processing in the last bath has been started it is no longer necessary to have an increased temperature within the storage tank. Therefore, after the processing in the last bath has been started said carbon dioxide within said storage tank is cooled down. That cooling can for example be achieved by passing gaseous carbon dioxide from the ullage or head space of the storage tank to a cooling unit, cooling it down and liquifying the carbon dioxide, and then transferring the cold carbon dioxide back to the storage tank. By that cooling the pressure within the storage tank is reduced. The cooling should be done in a manner that after the final distillation the pressure in the storage tank is sufficiently below the maximum design limit but still high enough to give reasonable cleaning or processing results in a proceeding process.

Some of the non condensed carbon dioxide entering the storage tank is condensed in direct heat exchange with the liquid carbon dioxide in the storage tank. This will increase the pressure. Further, the pressure will be increased by non condensed gas from the distilled stream. Since there is no agitation in the storage tank the gas on top of the liquid might be super heated compared to the liquid. In order to reduce the pressure quickly, pressure equilibrium between the storage tank and the still can be done.

In another embodiment the temperature within said storage tank and/or said cleaning chamber is maintained between 10° C. and 20° C. and/or is maintained depending on the maximum system pressure. A temperature of 20° C. corresponds to a pressure of 58 bars and the safety valve normally opens at 63 bars. The temperature range of 10° C. to 20° C. is based on the CO₂ cleaning systems as they are built today. If in the future a higher pressure is allowed in the cleaning machines and storage tanks, higher temperatures could also be used. For example, if the cleaning machine and the equipment is designed for pressures up to 70 bars, higher temperatures and pressures could be used.

After the parts have been processed in the last bath of carbon dioxide, the cleaning chamber is decompressed. During the decompression gaseous carbon dioxide is withdrawn from the cleaning chamber, compressed, cooled down and then transferred back into the storage tank. The compressed and cooled carbon dioxide can also be used to cool the carbon dioxide in the storage tank and to control the temperature in the storage tank.

According to another embodiment of the invention, water or any other medium which is used for cooling in one part of the cleaning system is used to heat up any other part of the cleaning system. Water which has been used as a cooling medium in the cooling unit heats up the cleaning chamber or the carbon dioxide entering the cleaning chamber. This can for example be done by applying coils outside the cleaning chamber and have the water exiting the cooling unit flow through these coils.

The heated cooling medium, for example water, could also be stored in a buffertank and used whenever needed anywhere in the CO₂ machine/process or in an external unit where heat is needed.

Most of the heat generated by the compressor will also end up in cooling water. For example after processing the parts in two baths of carbon dioxide approximately 100 liters of water have been utilized and the temperature of that cooling water has been raised to about 30 to 40° C. This water can also be used to heat the cleaning chamber or a stream of carbon dioxide by indirect heat exchange.

The use of water is that water is a low pressure system which is easy to handle and that a heating shell around any part of the system can easily be connected.

With the increased temperature any additives which are added to the liquid carbon dioxide and which contain molecules such as enzymes or water soluble surfactants will perform better during the cleaning. Further, the risk of crystallisation of some additives due to too low temperatures is prevented. The solubility of some compounds will be increased at higher temperatures.

The following additional embodiments of the invention will be described which allow to further control and/or increase the temperature in the cleaning chamber:

Liquid carbon dioxide from the storage tank is heat exchanged with a heated cooling medium, for example the compressor cooling water which has been heated by the compressor, before entering the cleaning chamber.

A heat exchanger could also be placed within the cleaning chamber and a heating medium such as heated water is passed through the heat exchanger in order to heat up the carbon dioxide after it has been transferred from the storage tank into the cleaning chamber.

During the cleaning operation liquid carbon dioxide could be pumped from the cleaning chamber through a heat exchanger and back into the cleaning chamber. In the heat exchanger the liquid carbon dioxide is heated up by heat exchange with a warm or hot medium such as water. Preferably a particle filter is used before or after the heat exchanger to remove any particles in the liquid carbon dioxide stream.

During cleaning operation liquid carbon dioxide is drained from the cleaning chamber and heat exchanged with a hot medium before being transferred to the still. The compressor sucks gas from the still and compresses it. The hot compressed gas is then transferred to the cleaning chamber without additional cooling instead of to the storage tank. In other words, during cleaning operation the carbon dioxide in the cleaning chamber is continuously distilled. The hot gas will then heat up the liquid carbon dioxide in the cleaning chamber while condensing. In cleaning operation any detergent or other additives will be lost with this operation. During extraction the continuous distillation will keep the extraction going up to a certain concentration of solute in the carbon dioxide.

During cleaning operation, gas from the cleaning chamber is sucked by the compressor, heat exchanged by a hot medium and transferred back to the cleaning chamber with the compressor. The compressor does not have to work that hard since the pressure difference to transfer it back to the cleaning chamber is very low. The hot gas will then heat up the liquid carbon dioxide in the cleaning chamber.

According to another embodiment used hot cooling water from the cleaning machine is collected in an external collection tank. The hot water can then be utilized in a water cleaning machine.

An outer weir, cascade or passage may be used around the cleaning chamber and the distiller. The weir, cascade or passage can be used to control the temperature in one or more of the following ways:

Hot cooling water from the cooling compressor is passed through the weirs around the cleaning chamber and the distiller during gas evacuation from the cleaning chamber to the storage tank. In this way the efficiency of the gas evacuation will be increased as well as the temperature in the distiller will be increased.

Warm cooling water from the cooling compressor is passed through the weirs around the distiller during distilling in order to increase the temperature in the distiller during the distilling sequence.

Hot water from the external collection tank is passed through the weir around the cleaning chamber when filling the cleaning chamber and running a cleaning process in order to increase the temperature in the cleaning chamber.

Hot water from the external collection tank is passed through the weir around the distiller before and during a dirt blow out cycle in order to increase the temperature in the distiller. In this way the temperature in the distiller is increased and a better separation of dirt in the carbon dioxide is achieved before the dirt blow out cycle.

Hot water from the external collection tank is run through the weir around the distiller between distilling cycles to increase the distiller temperature and to get a better distilling. In this way the amount of carbon dioxide which is transferred into the storage tank during process and stand still is increased.

When the outer weirs are not used for heating it is preferred to empty the weirs. This will heat isolate the cleaning chamber and the distiller and condensation of humidity on the cleaning chamber is avoided.

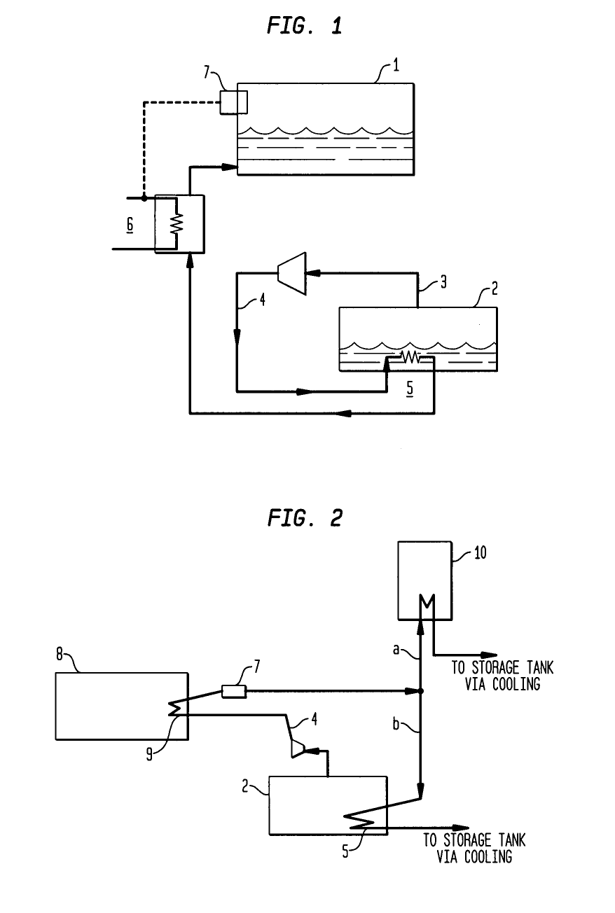

Referring to FIGS. 1-3, liquid carbon dioxide is stored in a storage tank 1 at a temperature of about 5 to 15° C. The cleaning process comprises the following steps: The parts to be cleaned are put into a cleaning chamber (not shown in the FIG. 1). The cleaning chamber is pressurized with gaseous carbon dioxide from the storage tank 1 until pressure equilibrium between the cleaning chamber and the storage tank 1 is achieved. The cleaning chamber is filled with liquid carbon dioxide from storage tank 1 and the cleaning operation is carried out.

Then the cleaning chamber is depressurized until a pressure equilibrium between the cleaning chamber and a still 2 is achieved and liquid carbon dioxide is transferred from the cleaning chamber to the still 2. At the top 3 of still 2 gaseous carbon dioxide can be withdrawn and be compressed by compressor 4. By that compression the gas is heated up and passed through a heat exchanger 5 within the still 2.

In heat exchanger 5 the gaseous carbon dioxide transfers heat to the liquid carbon dioxide in still 2. Due to that heat transfer the gaseous carbon dioxide is partially or fully liquified whereas liquid carbon dioxide within the still 2 is vaporized.

The liquid carbon dioxide leaving heat exchanger 5 is cooled in a cooling unit 6 and transferred back to the storage tank 1.

When the parts shall be cleaned in a second bath of dense phase carbon dioxide new liquid carbon dioxide is transferred from the storage tank 1 to the cleaning chamber before the distillation of the carbon dioxide starts which had been withdrawn from the cleaning chamber after the first bath.

It is also possible, and sometimes necessary, that the first bath is distilled before the second bath is filled from the storage tank. For example if the amount of carbon dioxide needed for one bath is more than 50% of what can be stored in the storage tank.

The parts may be cleaned in at least three baths of carbon dioxide. In that case the cleaning chamber is filled with liquid carbon dioxide from the storage tank 1 for the third time after the second bath has been withdrawn from the cleaning chamber. At this stage the storage tank 1 includes already the distilled carbon dioxide which had been transferred from the cleaning chamber via the still 2 to the storage tank 1 after the first bath.

In order to have in this third carbon dioxide bath a desired temperature, in particular to avoid a decrease in temperature compared to the carbon dioxide bath of the first cleaning cycle, cooling unit 6 is not run continuously during the whole distillation process but depending on the temperature in the cleaning chamber. That means the distilled carbon dioxide after the first bath, and after all subsequent baths, is cooled down to such a degree that a desired temperature is achieved in the cleaning chamber.

Cooling unit 6 is controlled in such a way that the temperature in the cleaning chamber increases from cleaning cycle to cleaning cycle. There is no need for external heat sources such as electrical or gas heaters to control the temperature in the cleaning chamber since the heat generated by compressor 4 is used for that purpose.

After the last bath and after the cleaning chamber has been drained the last time the gas in the cleaning chamber is sucked by the compressor 4, cooled down, condensed and passed into storage tank 1.

Finally the cleaning chamber is decompressed. When most of the gaseous carbon dioxide is withdrawn from the cleaning chamber the door to the cleaning chamber can be opened and the cleaned parts can be removed.

The last bath should be distilled before a new program can be started. During this distillation the cooling unit can be used some more than during the previous distillations in order to avoid that pressure and temperature in the storage tank getting too high. The cooling can also be controlled during the decompression of the carbon dioxide gas in the cleaning chamber.

FIG. 2 shows another alternative to increase the temperature in the cleaning chamber. During distillation the compressed carbon dioxide leaving the still 2 and compressor 4 can be heat exchanged with the carbon dioxide in the cleaning chamber 8 via a cooling loop 9 inside or outside the cleaning chamber 8. This carbon dioxide could also pass through the heat exchanger 5 in the still 2 (flow path b) in order to maintain boiling before passing through the cooling unit 6 and back to the storage tank 1.

The compressed and hot carbon dioxide could also be heat exchanged elsewhere in the system where heat is needed, for example with water in a buffer tank 10 (flow path a). In both ways, flow path a or flow path b, the carbon dioxide within the cleaning chamber is heated up while the carbon dioxide from the previous bath is distilled.

In order to add more heat to the system, a pressure regulator 7 could be installed after the cooling loop 9 in/outside the cleaning chamber 8. The regulator 7 could be set to a higher pressure than would be the normal counter pressure. The upstream pressure of the compressor 4 is therefore higher and the temperature of the carbon dioxide will be higher.

Downstream of the regulator the pressure is reduced. The increased pressure is thus only present in-between the compressor 4 and the regulator 7. If needed this pressure could therefore be higher than the system pressure, that is the pressure that the storage tank 1 can handle.

This generates more heat than the methods explained above but might consume more electricity.

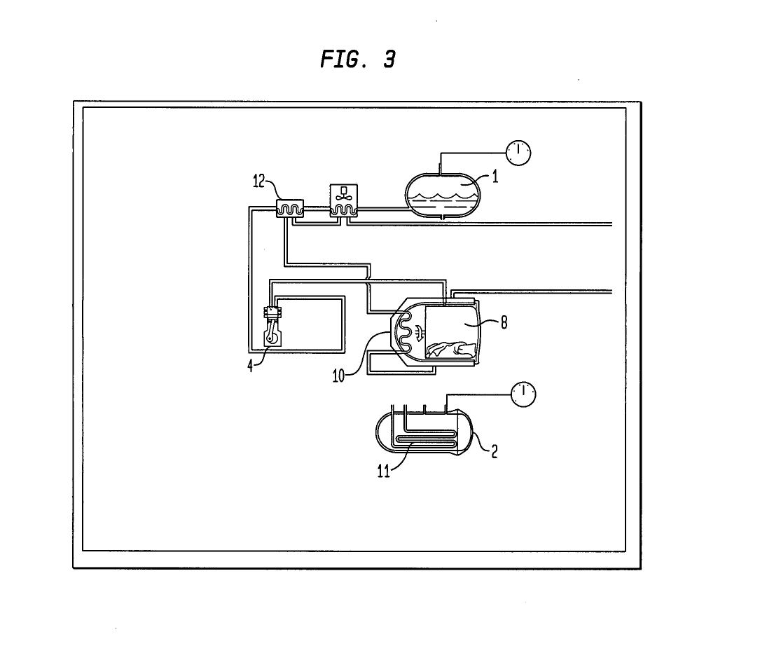

FIG. 3 shows another embodiment of the invention. A heat exchanger 10 is placed inside cleaning chamber 8. Another heat exchanger 11 is placed into the still 2. Water is passed through an external heat exchanger 12 and heated up in indirect heat exchange with warm carbon dioxide gas leaving the gas compressor 4. The water heated up in external heat exchanger 12 is then passed through heat exchanger 10 and/or heat exchanger 11 in order to heat up the cleaning chamber 8 and/or the still 2.

Another way to increase temperature in the cleaning chamber 8 is to pump gas with compressor 4 from the storage tank 1 to the cleaning chamber 8 during the cleaning cycle.

It will be understood that the embodiments described herein are merely exemplary and that a person skilled in the art may make many variations and modifications without departing from the spirit and scope of the invention. All such variations and modifications are intended to be included within the scope of the invention as defined in the appended claims. It will be understood that the embodiments described above are not only in the alternative, but may be combined.

What is claimed is:

1. A method for processing parts in more than one bath of dense phase carbon dioxide, wherein said processing in one of said baths comprises:
(a) transferring dense phase carbon dioxide from a storage tank to a cleaning chamber;
(b) processing said parts in said cleaning chamber with said dense phase carbon dioxide;
(c) withdrawing at least a part of said dense phase carbon dioxide from said cleaning chamber;
(d) distilling said withdrawn dense phase carbon dioxide;
(e) cooling said distilled carbon dioxide, wherein said cooling is carried out depending on a temperature and/or a pressure in the cleaning chamber; and
(f) transferring said cooled distilled carbon dioxide to said storage tank.

2. The method according to claim 1, wherein the temperature in said storage tank after step (f) is higher than the temperature before step (f).

3. The method according to claim 1, wherein the temperature in said cleaning chamber after step (f) is higher than the temperature before step (f).

4. The method according to claim 1, wherein steps (a) to (f) are repeated a plurality of times.

5. The method according to claim 4, wherein steps (a) to (f) are repeated more than 3 times.

6. The method according to claim 1, wherein after step (a) has been carried out for a last time a temperature of said carbon dioxide within said storage tank is cooled down.

7. The method according to claim 1, wherein the temperature of said cleaning chamber is maintained between 5° C. and 20° C.

8. The method according to claim 1, wherein the temperature of said cleaning chamber is maintained depending on a maximum pressure of a system for the method.

9. The method according to claim 1, wherein said parts are cleaned.

10. The method according to claim 1, wherein said parts are impregnated with materials.

11. The method according to claim 1, wherein said cooling carbon dioxide is carried out depending on a temperature and a pressure in the storage tank.

12. The method according to claim 1, wherein said cooling carbon dioxide is carried out depending on a temperature in the storage tank.

13. The method according to claim 1, wherein said cooling carbon dioxide is carried out depending on a pressure in the storage tank.

14. The method according to claim 1, further comprising using said distilled carbon dioxide for heating carbon dioxide within said cleaning chamber by indirect heat exchange.

15. The method according to claim 1, wherein cooling said distilled carbon dioxide is with a cooling medium, said cooling medium used for heating said cleaning chamber.

16. The method according to claim 15, wherein said cooling medium comprises water.

17. The method according to claim 1, wherein cooling said distilled carbon dioxide is with a cooling medium, said cooling medium used for heating a stream of carbon dioxide.

18. The method according to claim 17, wherein said cooling medium comprises water.
